(19) United States
(12) Patent Application Publication
(10) Pub. No.: US 2007/0031970 A1
(43) Pub. Date: Feb. 8, 2007

(54) Recovery of components from solid support devices

(75) Inventors: William Wilson, Suffolk (GB); Matthew Jones, Somerville, MA (US)

Correspondence Address: NIXON & VANDERHYE, PC, 901 NORTH GLEBE ROAD, 11TH FLOOR, ARLINGTON, VA, 22203, US

(73) Assignee: MILLENNIUM PHARMACEUTICALS, INC, Cambridge, MA (US)

(21) Appl. No.: 10/549,128

(22) PCT Filed: Mar. 19, 2004
(86) PCT No.: PCT/GB04/01190

§ 371 Date: May 22, 2006

(30) Foreign Application Priority Data
Mar. 26, 2003 (GB) 0306914.3

(51) Int. Cl. G01N 35/00

(52) U.S. Cl. 436/43

(57) ABSTRACT

Recovery apparatus for recovering radio frequency tags from solid support devices in the form of cans (2) which include such tags and also resin on which chemical compounds are synthesized includes a stack of cans (2) which are fed into the apparatus wherein they are received within a port (28) of a rotating disc (26). The disc rotates to a position adjacent to a magnet 32 and blade (34). In this position, the magnet attracts the radio frequency device so that it is raised upwardly towards the lid end of the can, whereafter the blade (34) is able to slice through the lower end of the can to open it, whereupon the solid support resin falls out of the can into a receptacle (36). The disc continues to move until the remains of the can are over a receptacle (40), whereupon the magnetic force is released so the tag falls into receptacle (40) from which it may be retrieved, for re-use.

This invention relates to solid support devices and particularly, although not exclusively, relates to the recovery of components from solid support devices.

The use of solid support devices in the synthesis, in parallel array or combinatorial techniques, of compounds such as peptides or other chemical compounds is well known. A widely used device for use in combinatorial techniques is sold by Irori and is known as a MICROKAN (Trade Mark). It comprises a porous plastics frusto-conical container containing solid support resin for supporting compounds synthesized and an identification means, for example a radio frequency tag. The container is closed by a lid arranged at its upper end which is intended to securely close the can and be substantially irremovable. Further details may be found in W096/36436 (Irori) especially FIG. 14 thereof.

The MICROKANS are used to prepare respective multiple different compounds on the solid support resin and the identification means allows each MICROKAN to be uniquely identified for recording the processes to which each has been subjected. After preparation, the compounds are cleaved from the resin and isolated, leaving the MICROKANS containing the resin and the identification means.

Identification means in the form of, for example radio frequency tags are relatively expensive (of the order of £4 sterling) and given the fact that many thousand MICROKANS (and therefore tags) may be used in a single combinatorial technique, the overall cost of the tags alone can run into many thousands of pounds sterling Accordingly, there is a strong incentive to retrieve tags for re-use.

A customized hand tool is available for forceably removing the lids which close the MICROKANS to allow the resin and tags to be removed. Removal of the lid destroys the MICROKANS but the tags in particular can be re-used. Disadvantageously, use of the aforementioned hand tool is time-consuming and an operator using the tool risks repetitive strain injury (RSI).

It is an object of the present invention to address the above described problem.

According to a first aspect of the invention, there is provided a method of recovering an identification means associated with a solid support device, the method comprising:

(i) causing said identification means to be positioned in a first region of said solid support device;

(ii) detaching a first portion of the device which is spaced from said first region to define a first opening in said device; and

(iii) removing the identification means from the support device via said first opening.

Preferably, the method includes applying a magnetic force to the identification means to retain it in position. The method may involve reducing the level of magnetic force applied to the identification means to enable said identification means to be removed from the support device via said first opening.

Preferably, step (i) of the method comprises applying a magnetic force in the region of the solid support device in order to attract said identification means and retain it within said first region of the solid support device. Said magnetic force is preferably arranged to act against the gravitational force acting on the identification means. Preferably, said magnetic force is applied from a position above the identification means and, more preferably, above said support device.

Said solid support device may include a hollow body closed by a closure means. Both the hollow body and closure means are preferably not attracted to a magnetic force. They are preferably made of a plastics material. Said closure means may be substantially immovably fixed in position. Said closure means is preferably provided at a first end of the device. Preferably, in the method, the distance between said first region of the device and said first end is less than the distance between said first portion of the device and said first end. Thus, preferably, in step (i), said identification means is positioned at or adjacent said first end of said support device.

In step (ii), the method preferably comprises detaching said first portion by contacting the solid support device with a detachment means which may suitably comprise a blade. Preferably, the method comprises moving said solid support device relative to a stationary detachment means. The method may comprise the detachment means slicing the solid support device to detach said first portion. By positioning said identification means in said first region, said detachment means suitably does not contacts (and is suitably not interfered with by) said identification means during step (ii).

Preferably, during step (ii), the device is restricted from pivoting, suitably, by it being wedged between two parts.

In step (iii), said identification means may be removed by allowing it to fall under gravity through said first opening, suitably to a predetermined location, for example into an identification means collection receptacle. Suitably, when the method involves applying a magnetic force in step (i) to retain said identification means in said first region, the method comprises reducing the level of the magnetic force applied after detachment of said first portion in step (ii).

Preferably, said method comprises recovering a multiplicity of identification means associated with a multiplicity of solid support devices. Preferably, each solid support device of said multiplicity includes a single, suitably unique, identification means. Said multiplicity of solid support devices may comprise devices used in a combinatorial or parallel array technique for preparing a multiplicity of chemical compounds.

The method preferably includes the step of arranging a multiplicity of solid support devices in a receptacle prior to step (i). The method may include feeding said solid support devices in line, with each preferably being orientated in the same predetermined manner, towards a region wherein step (i) is undertaken.

The method may include feeding said solid support devices to a rotating member which transports the devices to stations in which the steps of the method are undertaken. The rotating member may rotate continuously (without stopping) between stations in which method steps (i), (ii) and (iii) are undertaken. The rotating member may rotate at between 0.1 to 50 rpm, preferably 0.5 to 25 rpm, more preferably 0.5 to 15 rpm, especially 1 to 10 rpm.

Said solid support device preferably contains said identification means and a solid support material, for example a resin, prior to step (i). Said solid support device is preferably-for making a chemical compound. It suitably comprises (a) a container, (b) a solid support resin reversibly linkable to one or more chemical compounds, the solid support resin being inside the container (c) and identification means which is magnetic.

The method may include the step of carrying out one or more chemical reactions on the solid support resin prior to step (i). This may involve contacting the solid support device with a fluid which is or which contains a reagent. The fluid preferably passes through an opening in an outside wall of the solid support device to contact the solid support resin which is positioned with the device. A chemical compound prepared may be cleaved from the solid support resin prior to step (i). This may involve contacting the device with a cleavage formulation which preferably comprises a fluid.

Said method preferably includes the step of separating the identification means and said solid support material. Preferably, said solid support material is removed from the device after step (ii), suitably via said first opening and, thereafter, the identification means is removed from the device in step (iii).

Preferably, in the method after step (ii), said solid support material may be removed by allowing it to fall under gravity through said first opening, suitably to a predetermined location, for example into a resin collection receptacle. Preferably, during this removal, said identification means is restricted from also being removed by a magnetic force, suitably applied in step (i) as described.

Preferably, after step (iii), the method comprises directing the remainder of the support device(s) to a support device collection receptacle.

According to a second aspect of the invention, there is provided apparatus for recovering an identification means associated with a solid support device, the apparatus comprising:

(a) positioning means for causing an identification means of a solid support device to be positioned in a first region of the solid support device; and

(b) detachment means for detaching a first portion of the device to define a first opening therein.

Said positioning means preferably comprises a magnet, which is suitably arranged to apply a magnetic force on an identification means to retain it in said first region.

Said apparatus preferably includes means defining a predetermined travel path for the solid support device. Said positioning means, for example said magnet, is preferably arranged to apply a magnetic force above the travel path, suitably so as to hold the identification means in said first region against the force of gravity.

Said detachment means preferably is arranged to cut the solid support device for detaching said first portion thereof. Said detachment means is preferably arranged below the positioning means, for example said magnet.

Said apparatus preferably includes a transportation means for transporting the solid support device along the travel path. Said transportation means is preferably rotatable. Said transportation means preferably includes cooperation means for receiving a solid support device and retaining it in position during travel along at least part of the travel path. Said cooperation means preferably comprises an opening for seating a solid support device. The apparatus is preferably arranged for seating a solid support device such that part thereof protrudes below the transportation means such that the portion which protrudes may be contacted in use by said detachment means for detaching the first portion of the device as described. Said transportation means may include a plurality, preferably at least 3, more preferably at least 4 of said cooperation means.

Said apparatus preferably includes a resin collection receptacle associated with the travel path, downstream of said detachment means. Said collection receptacle is preferably arranged below said positioning means, for example said magnet when provided. The resin collection receptacle is preferably arranged to receive material which may fall, in use, from a solid support device after detachment of the first portion by said detachment means as described. When the apparatus includes a transportation means as described, said resin collection receptacle is preferably arranged below said transportation means.

Said apparatus preferably includes an identification means collection receptacle associated with the travel path downstream of the detachment means and, when provided, the resin collection receptacle. Said identification means collection receptacle is preferably both laterally and vertically spaced from said positioning means, for example said magnet suitably so that, in use, any magnet force impinging on identification means in a solid support device which is directly above the identification means collection receptacle is insufficient to prevent an identification means falling from the device, under gravity, into the receptacle.

Said apparatus preferably includes collection means for collecting the remainder of solid support devices after their passage through the apparatus.

Said apparatus preferably includes feeder means for feeding respective solid support devices in turn to a position for cooperation with said positioning means and/or said detachment means. Where the apparatus includes a transportation means as described, said feeder means is preferably arranged to feed solid support devices to the transportation means. Said feeder means is preferably arranged to assemble an upright stack of solid support devices which may be fed in turn to the transportation means.

Said apparatus is preferably arranged to recover identification means from solid support devices having a maximum dimension of less than 10 cm, preferably less than 5 cm, especially less than 3 cm. The maximum diameter of the solid support devices may be 2 cm or less, preferably 1.5 cm or less, more preferably 1 cm or less.

According to a third aspect of the invention there is provided an assembly comprising apparatus according to the second aspect in combination with a multiplicity of solid support devices.

Any feature of any aspect of any invention or embodiment described herein may be combined with any feature of any aspect of any other invention or embodiment described herein mutatis mutandis.

Specific embodiments of the invention will now be described, by way of example, with reference to the accompanying schematic drawings, in which:

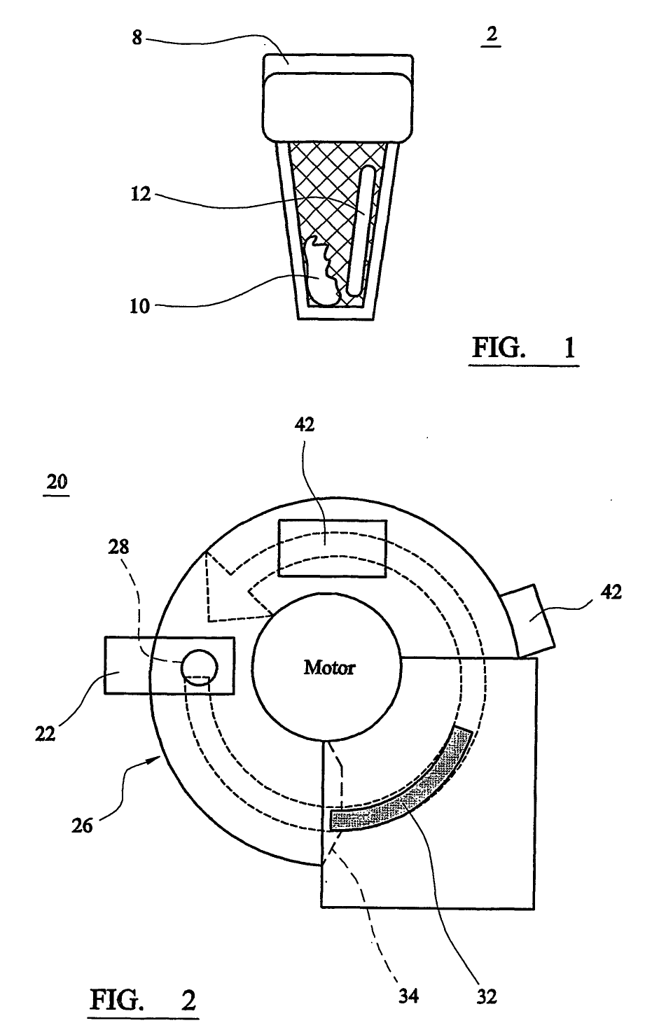

FIG. 1 is a cross-section through a solid support device in the form of a can;

FIG. 2 is a simplified plan view of a recovery apparatus;

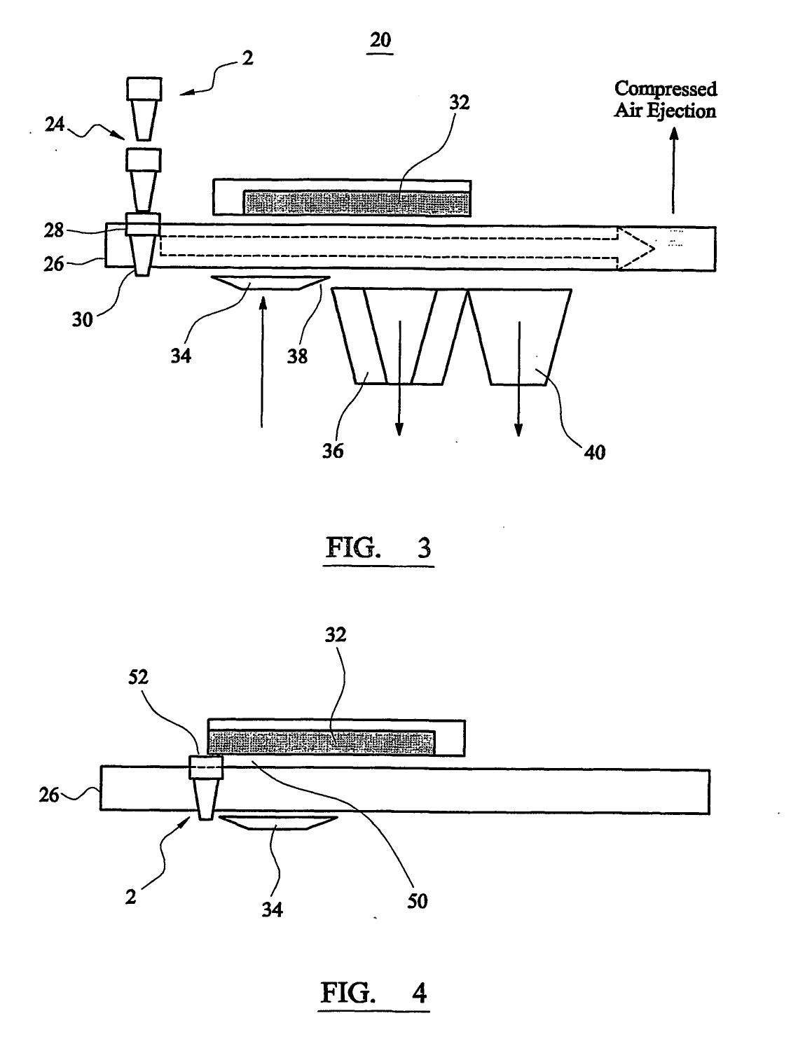

FIG. 3 is a simplified side elevation of recovery apparatus; and

FIG. 4 is part of the side elevation of FIG. 3 showing the magnet physically holding the can in position.

Referring to FIG. 1, the can 2 (which may be a MICROKAN (Trade Mark)) includes a frusto-conical plastics container 4 which has perforated side walls 6 and is closed by a lid 8 which is intended to be substantially permanently closed so that it cannot inadvertently open during the range of processes to which the can 2 may be subjected in use. The can 2 contains a piece of solid support resin 10 (from which a compound prepared has been cleaved) and a radio frequency tag 12 which uniquely identifies the can 2. The resin and tag are freely movable within the can 2.

The recovery apparatus 20, shown in FIGS. 2 and 3, is essentially arranged to carry out the following steps:

(i) To feed cans 2 in a line in an orderly reproducible manner so that they are orientated with their lid 8 uppermost;

(ii) To apply a magnetic force to each can in turn to cause the tag 12 to move upwardly towards the lid end of the can 2;

(iii) To cut the bottom off the can whilst the tag 12 is held away therefrom by the magnetic force;

(iv) To allow the resin to fall from the can into a resin collection receptacle, whilst the tag is retained at the lid end of the can by the magnetic force;

(v) To release the magnetic force to allow the tag 12 to fall from the can into a tag collection receptacle;

(vi) To direct the remainder of the can into a support device collection area; and

(vii) To continue the aforementioned steps on a subsequent can in the line.

Further details on the apparatus are provided below. It should be noted that FIG. 2 shows elements of the apparatus arranged in a circular manner which is how the apparatus is arranged in reality, whereas FIG. 3 shows elements of the apparatus in line to schematically illustrate the sequence of steps in the recovery of tags.

A bowl feeder (not shown) is used to feed the cans 2. The feeder is arranged to vibrate to orientate the cans and, when orientated, a compressed air jet directs the cans in line into a feed tube 22 (FIG. 2) which contains the cans in a vertical stack 24 as illustrated in FIG. 3. The feed tube is arranged to deliver the cans, individually, to a rotating disc 26.

The rotating disc 26 includes four ports 28 arranged at 90° intervals around the disc, towards the periphery thereof. Only one such port 28 is shown in the figures in the interests of clarity. The ports 28 ate arranged to support the cans with their lid ends uppermost and so that their lower ends 30 protrude from a lower face of the disc 26, as shown in FIG. 3.

Downstream of the feed tube 22, the recovery apparatus includes permanent magnets 32, arranged above the disc 26, and a fixed blade 34 arranged below the disc 26 at a level such that it may slice off the lower end 30 of a can as the can passes.

The rotating disc 26 moves a can from a position adjacent the feed tube 22 towards the magnets 32 and blade 34. Just prior to the blade 34 contacting a can, the tag 12 within the can is subjected to a magnetic force by the magnet 32 which raises it upwardly towards the lid end of the can and away from the lower end 30; and the can is held upright within the port by the magnet 32. More particular, the magnet is positioned so that its lower face 50 abuts upper end 52 of the can so that the can cannot pivot as it passes underneath the magnet. The rotating disc 26 then causes the can to contact the fixed blade 34 which slices through the lower end of the can and, therefore, effectively opens it. The rotating disc continues to rotate and moves the can towards a resin collection receptacle 36 which is arranged immediately after end 38 of the blade 34. As the can moves downstream of the blade 34, and directly above the receptacle 36, the resin in the can is able to fall, under gravity, into the receptacle.

Downstream of the receptacle 36 (and downstream of the magnets 32), a tag collection receptacle 40 is arranged. The rotating disc moves the can downstream of the receptacle 36 and over receptacle 40 to a position at which the tag 12 is not subjected to a sufficient magnetic force to retain it at the lid end of the can. Consequently, the tag falls, under gravity, into the receptacle 40.

Thereafter, a notch (not shown) on the rotating disc activates a contact switch 42 which initiates the feeding of another can into the feed tube 22 and activation of a compressed air device 42 which is arranged to direct an air jet at the now empty remains of the can to eject the can upwardly into a vacuum suction device (not shown) arranged above the position of ejection. The vacuum suction device directs the can to a collection bag (not shown).

Finally, the rotating disc moves the now empty port 28 under a contact switch which is arranged to act as a safety cut out. If the port is empty (which it should be at this stage), then the empty port passes under the feed tube 22 and the process starts again by a further can being delivered into the port. However, if the port is not empty (for example, due to a failure in the ejection of it by the compressed air device) the switch is activated and power to the system is shut down to prevent a port containing a can (or part thereof) passing under the feed tube 22 since this might otherwise damage the apparatus.

It should be appreciated that, in normal operation, the rotating disc is driven continuously with each of its four ports receiving cans. The disc itself rotates at approximately 3 rpm. The apparatus is able to process about 720 cans an hour. Advantageously, the tags are separated for re-use; and the resin and remains of the cans are separated from one another for appropriate disposal.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of recovering an identification means associated with a solid support device, the method comprising:
(i) causing said identification means to be positioned in a first region of said solid support device;
(ii) detaching a first portion of the device which is spaced from said first region to define a first opening in said device; and
(iii) removing the identification means from the support device via said first opening.

2. A method according to claim 1, which includes applying a magnetic force to the identification means to retain it in position.

3. A method according to claim 2, which involves reducing the level of magnetic force applied to the identification means to enable said identification means to be removed from the support device via said first opening.

4. A method according to claim 1 wherein step (i) of the method comprises applying a magnetic force in the region of the solid support device in order to attract said identification means and retain it within said first region of the solid support device.

5. A method according to claim 1, wherein, in step (ii), the method comprises detaching said first portion by contacting the solid support device with a detachment means comprising a blade.

6. A method according to claim 1, wherein in step (iii), said identification means is removed by allowing it to fall under gravity through said first opening.

7. A method according to claim 1, wherein a magnetic force is applied in step (i) to retain said identification means in said first region and the method comprises reducing the level of the magnetic force applied after detachment of said first portion in step (ii).

8. A method according to claim 1, which comprises arranging a multiplicity of solid support devices in a receptacle prior to step (i) and feeding said solid support devices in line towards a region wherein step (i) is undertaken.

9. A method according to claim 1, which includes feeding said solid support device to a rotating member which transports the device to stations in which method steps (i), (ii) and (iii) are undertaken.

10. A method according to claim 1, which includes the step of separating the identification means and said solid support material.

11. A method according to claim 1, wherein after step (ii), said solid support material is removed by allowing it to fall under gravity through said first opening, wherein, during removal, said identification means is restricted from also being removed by a magnetic force.

12. A method according to claim 1, wherein after step (iii), the method comprises directing the remainder of the support device to a support device collection receptacle.

13. A method according to claim 1, wherein said solid support device is for making a chemical compound, said device comprising: (a) a container, (b) a solid support resin reversibly linkable to one or more chemical compounds, the solid support resin being inside the container (c) an identification means inside the container which is magnetic.

14. A method according to claim 13, which includes contacting said solid support device with one or more reagents prior to step (i) for preparing a chemical compound on said solid support resin.

15. A method according to claim 13 which includes cleaving a chemical compound from the solid support resin prior to step (i).

16. Apparatus for recovering an identification means associated with a solid support device, the apparatus comprising:
(a) positioning means for causing an identification means of a solid support device to be positioned in a first region of the solid support device; and
(b) detachment means for detaching a first portion of the device which is spaced from the first region to define a first opening therein.

17. Apparatus according to claim 16 for carrying out a method of recovering an identification means associated with a solid support device, the method comprising:
(i) causing said identification means to be positioned in a first region of said solid support device;
(ii) detaching a first portion of the device which is spaced from said first region to define a first opening in said device; and
(iv) removing the identification means from the support device via said first opening.

18. Apparatus according to claim 16, wherein said positioning means comprises a magnet which is arranged to apply a magnetic force on an identification means to retain it in said first region.

19. Apparatus according to claim 16, which includes means defining a predetermined travel path for the solid support device wherein said positioning means is arranged to apply a magnetic force above the travel path so as to hold the identification means in said first region against the force of gravity.

20. Apparatus according to claim 16, wherein said detachment means is arranged to cut the solid support device for detaching said first portion thereof.

21. Apparatus according to claim 16, which includes a rotatable transportation means for transporting the solid support device along the travel path.

22. Apparatus according to claim 21, wherein said transportation means includes cooperation means for receiving a solid support device and retaining it in position during travel along at least part of the travel path, wherein said cooperation means comprises an opening for seating a solid support device such that part thereof protrudes below the transportation means whereby the portion which protrudes may be contacted in use by said detachment means for detaching the first portion of the device.

23. Apparatus according to claim 21, which includes a plurality of cooperation means.

24. Apparatus according to claim 16, which includes a resin collection receptacle associated with the travel path, downstream of said detachment means.

25. Apparatus according to claim 16, which includes an identification means collection receptacle associated with the travel path downstream of the detachment means.

26. Apparatus according to claim 16, which includes collection means for collecting the remainder of solid support devices after their passage through the apparatus.

27. Apparatus according to claim 16, which includes feeder means for feeding respective solid support devices in turn to a position for cooperation with said positioning means and/or said detachment means.

28. Apparatus according to claim 16, wherein said support device is for making a chemical compound, said device comprising (a) a container, (b) a solid support resin reversibly linkable to one or more chemical compounds, the solid support resin being inside the container and (c) an identification means inside the container which is a magnetic.

29. An assembly comprising apparatus according to claim 13 in combination with a multiplicity of solid support devices.
